(19) United States
(12) Patent Application Publication
(10) Pub. No.: US 2008/0213739 A1
(43) Pub. Date: Sep. 4, 2008

(54) School-level outcome standard setting method

(75) Inventors: David Thomas Stern, Ann Arbor, MI (US); Miriam Friedman Ben-David, New York, NY (US); Shaul (Miriam F.) Ben-David, Tel Aviv (IL)

Correspondence Address: Paul D. Greeley;Ohlandt, Greeley, Ruggiero & Perle, L.L.P., 10th Floor, One Landmark Square, Stamford, CT, 06901-2682, US

(73) Assignee: CHINA MEDICAL BOARD

(21) Appl. No.: 12/009,745

(22) Filed: Jan. 22, 2008

Related U.S. Application Data
(60) Provisional application No. 60/881,327, filed on Jan. 19, 2007.

(51) Int. Cl. G09B 7/00

(52) U.S. Cl. 434/322

(57) ABSTRACT

A standard setting method for schools including establishing a student level standard, generating a school-level standard based on a percentage of students that meet the student-level standard for performance criteria, and generating a report.

### CROSS-REFERENCE TO RELATED APPLICATIONS

This application claims the benefit of Provisional Application Ser. No. 60/881,327, filed Jan. 19, 2007, the contents of which are incorporated by reference herein.

### BACKGROUND

1. Field of the Disclosure

This disclosure relates generally to standard setting systems and, more particularly, to a method for establishing and/or reporting one or more school-level standards.

2. Description of the Related Art

National and local authorities are calling for evidence of educational outcomes, in particular, in the medical field. Medical Doctor (M.D.) degrees are granted by a variety of institutions around the world, with no established objective mechanism to identify those institutions qualified to grant this degree. Because of the critical need and high stakes of providing medical care, the profession of medicine must establish and maintain quality standards.

As much as student-level standards are essential to determine if graduates are to attain the expected competences for the next phase of their training, it is also essential to evaluate the quality of the school and its capacity to deliver an educational program that facilitates the attainment of outcomes. Consequently, outcome-based standards seek student-level standards as well as school-level standards. The purpose of student-level standard setting is to identify the cut-off point above which a student can be considered competent.

Existing methods to identify quality of medical education institutions lack independence, international credibility, reproducibility, and verifiability.

Accordingly, there is a need for a method for establishing and/or reporting one or more school-level standards. There is additionally a need for a method for assessing characteristics of educational institutions on outcome standards. There is also a need for assessing characteristics of educational institutions on outcome standards that are not performed by the institution itself, but only through external independent examination of the performance of graduates. There is still a further need for school-level standards to identify the cut-off point above which the school can be considered competent.

### SUMMARY

A standard setting method for schools is provided. The method includes establishing a student level standard, generating a school-level standard based on a percentage of students that meet the student-level standard for performance criteria, and generating a report.

Establishing the school-level standard may comprise the step of identifying at least one panelist. The panelists may review an examination that assesses the performance criteria, the student-level standards for the examination, and discuss characteristics of borderline schools. Establishing the school-level standard may comprise each panelist estimating the tolerable percentage of failing students in a borderline school. Among the panelists, there may be a high estimated percentage and a low estimated percentage that may be reviewed. The estimated percentage may be revised.

The method may further comprise averaging the revised percentage, thereby generating the school-level standard. The method may further comprise applying the school-level standard to each of the schools. Generating a report may comprise generating a report identifying a first category that is greater than the school-level standard, a second category that is less than the school-level standard and/or a third category within a predetermined borderline range of the school-level standard. The first category, the second category, and the third category may include students, schools, or combinations of schools (e.g., by region or country).

The method may further comprise identifying the performance criteria. The method may further comprise administering an examination, which assesses a student's ability in the performance criteria. Establishing a student level standard may comprise establishing the student-level standard for the examination.

The above-described and other features and advantages of the present disclosure will be appreciated and understood by those skilled in the art from the following detailed description, drawings, and appended claims.

### BRIEF DESCRIPTION OF THE DRAWINGS

FIG. 1 is a table illustrating examplary methods used to examine competency domains;

FIG. 1a is an examplary graphical depiction of consequential data that may be shown after a first round of rating with a heavy line representing a student-level standard set by a prior panel;

FIG. 2 is a table illustrating examplary schools and percentage of students below a domain standard of each corresponding school;

FIG. 3 is a table illustrating examplary initial and revised school-level ratings; and

FIG. 4 is an examplary block diagram showing the steps of the school-level outcome standard setting method.

### DETAILED DESCRIPTION

The present disclosure provides an independent, international, verifiable standard setting method for ensuring that institutions or schools are qualified to grant a degree. The method will be described in relation to a method for ensuring that institutions are qualified to grant a medical degree. However, the method may be used for other educational degrees.

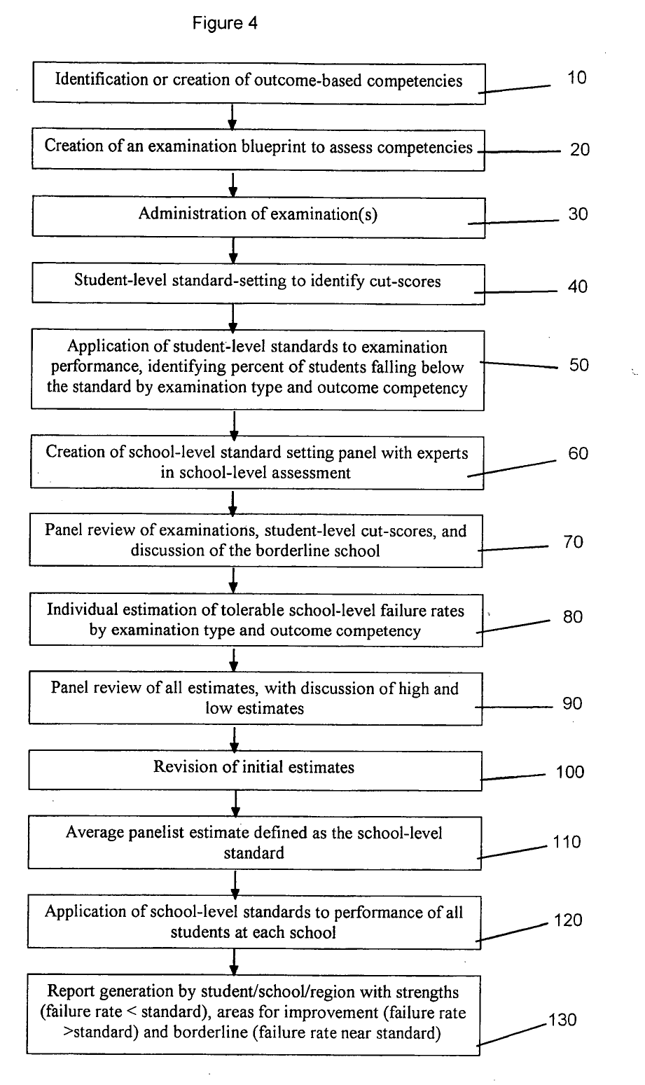

The method may include establishing global minimum essential outcomes or identifying or creating outcome-based competencies, as shown as step 10 in FIG. 4, for all medical graduates. The global minimum essential outcomes may be categorized into domains, such as, for example, professional behavior and ethics, scientific foundations, communication skills, clinical skills, population health, information management, scientific thinking, any other domains related to global minimum essential outcomes, and any combination thereof.

The global minimum essential outcomes are evaluated through a variety of examinations. Examination may be conducted, for example, using three assessment methods: the multiple-choice question (MCQ) examination in which those being tested are provided with a set of written questions and fixed response options from which to choose; the objective structured clinical examination (OSCE) in which those being tested engage in a series of interactive exercises with standardized patients or standardized materials (such as radiographs) in a sequential and timed fashion; and longitudinal faculty assessment in which those being tested are evaluated by supervisors as they engage in daily work-related tasks over a prolonged period (1 to 3 months).

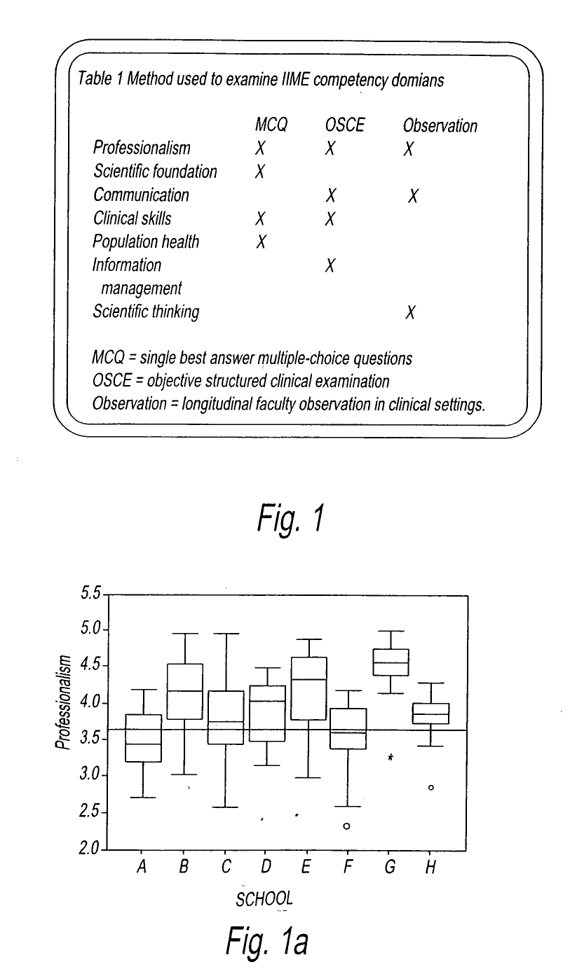

The types of examination and their linkage to outcomes may be reviewed and approved, for example, by international regulatory and advisory bodies. A blueprint may be created for a set of examinations to measure student abilities to demonstrate these outcomes, as shown as step 20 in FIG. 4. The blueprint and design of the examinations may be implemented at target institution(s), as shown as step 30 in FIG. 4. For example, students, such as, year 7 (graduating) students at eight leading medical schools in China, using a 150-item MCQ examination, a 15-station OSCE, and a 16-item faculty observation form may be used at least once per month for 3 months on each student. Each assessment type may measure multiple domains of competence, as shown in FIG. 1. When this set of assessments are completed, there are over 200,000 data points on graduating students at eight schools.

Student-level standards may be set for these examinations, as shown as step 40 in FIG. 4. Student-level standards for examination performance may be established by setting cut-scores prior to, or using the results of the implementation. For example, a predetermined characteristic or score on each domain of each examination would constitute acceptable student performance. The type of examination may be discussed to determine how students are expected to perform at a school considered acceptable, not acceptable, and/or borderline in a predetermined range between acceptable and unacceptable.

Student performance is aggregated by school. The percentage of students below a predetermined cut-score is calculated for each domain of each examination or component of an examination, as shown as step 50 in FIG. 4. For example, an OSCE on which there may be a communication skills composite score (averaged over multiple stations) ranging from 1 (low performance) to 5 (high performance). A student-level standard-setting panel reviews the OSCE stations and scale, and arrives at a cut-score of 3.9. Any individual student who scores above this would be considered to meet the standard; below it, the student would be considered to have an educational weakness that needs attention. At the school-level, an aggregate of student performances might indicate that 1%, 10% or 50% of students fall below the student-level standard.

A school-level standard setting procedure is implemented and determined, for example, by one or more panelists, as shown as step 60 in FIG. 4, such as, a panel of international experts. Implementing and determining a new standard setting procedure includes determining characteristics of a borderline school, reviewing student-level cut scores and examinations, as shown as step 70 in FIG. 4. Discussion among the panel of international experts may be conducted of the borderline school in a manner similar to that done during Angoff-method discussions of a borderline student. The discussion during Angoff procedures involves engaging the group of panelists in a discussion of the ways in which a school could be considered marginal. Using experts who have seen many schools and evaluated them for licensing purposes, a discussion ensues which describes characteristics of the borderline school. Such a discussion helps all members of the panel to understand and conceptualize the same dimensions.

Relative difficulty of a borderline school to achieve acceptable standards for a given examination and competency domain is determined. In standard setting procedures, panelists may be provided with information that helps them decide how realistic their estimates of the relative difficulty of a borderline school to achieve acceptable standards for a given domain may be. In determining relative difficulty of a borderline school to achieve acceptable standards for a given domain, panelists may consider the question: In a borderline school, what will be the likelihood of achieving minimal competency on each one of the domains?

The method may include providing panelists assessment materials. Panelists may review all test items assigned to each domain by assessment type. Multiple methods for assessing a single domain may be used. The providing step may be repeated for each competency domain and measurement type (e.g., MCQ, OSCE, Faculty Observation).

Student-level standards may be reviewed based on the assessment materials for each domain. Panelists review the student-level standards or student cut-score, for each one of the assessment methods and competency domains.

Initial estimates of a portion of students below the predetermined standard tolerable in a borderline school for each of the assessment instruments per domain provided are determined, as shown as step 80 in FIG. 4. The initial estimates of a portion of students below the predetermined standard tolerable in a school or borderline school for each of the assessment instruments per domain provided may be determined by panelists. For example, if only 1% of students in a school fall below the student-level cut-score, the school may be considered to meet the school-level standard. At some point along the continuum, such as, for example, if 50% of students fall below the student-level cut off score, the school would not meet the school-level standard. The percentage identified along this continuum defines the school-level standard. Panelists may be shown a projection of their initial ratings on a screen and discuss high and low ratings, as shown as step 90 in FIG. 4. Anonymous school-level data may be shown to provide consequential data of the school-level cut-scores on the percent of students that fall below the domain standard for each school.

The estimates of a percentage of students below the predetermined standard tolerable in a borderline school for each of the assessment instruments per domain are revised, as shown as step 100 in FIG. 4.

A final revised rating or standard is generated. The final revised rating may be an average of the revised estimates, as shown as step 110 in FIG. 4.

The revised rating may be applied to school-level data, as shown as step 120 in FIG. 4. For example, schools having a lower percentage of students below the cut-score of the final revised rating would meet or comply with the final revised rating, and a greater percentage of students below the cut-score would not meet or comply with the final revised rating.

Using the combination of student and school-level standards, all student scores may be entered into a database, and the analytical procedures above may be applied, as shown as step 130 in FIG. 4. For example, the final ratings and school-level data may be inputted in to a database or spreadsheet and the final ratings applied in the database or spreadsheet, for example, by Excel®, to the school-level data. Specific reports for each student, each school, and the aggregate of all schools may be generated.

The following is an example of the method of the present disclosure. In any standard-setting process, an element is the choice of those who will set the standard. A target is set as the competency of a school, so panelists, individuals or committee members are selected who have close contact with and substantial experience in evaluating schools, such as, medical schools. For example, committee members may serve as deans of medical schools, health ministry advisors, or on external review committees, most committee members may have had the opportunity to observe and evaluate a wide range in quality of medical schools internationally. In addition, panelists may be chosen to create geographic or content expertise diversity. Sixteen individuals may be selected that have been employed as educational leaders in 13 different countries—some may be doctors, some may be in the basic sciences, and may be experts in medical education.

All individuals are sent materials in advance of the meeting, including papers on the Institute for International Medical Education (IIME), associated with the assignee, project and standard setting, and sample examination materials from the three examination instruments.

The opening session of the meeting includes a review of the IIME project, a review of standard-setting methods, and a description of the student-level standards set, for example, previously by a different panel. In this presentation, the details of participants, standard-setting processes and outcomes are provided. Decisions about which cut-off scores to use, for example, Angoff, Hofstee, or combination thereof, are reviewed, and the student-level standards are approved by the committee. A task for setting school-level standards is to get a committee of international experts to simultaneously consider the competency domains and examination items, and the percentage of students who could fall below a cut-off score while still allowing the school to be considered as meeting competencies.

A discussion by the committee members of the borderline school in a manner similar to that used during Angoff method discussions of the borderline student is conducted. The borderline discussion generates a profile of the borderline school agreed by all international participants. For example, borderline schools might exist because they accept students with lower initial abilities, because their programs of education are incomplete, or because the school invests inadequate resources in education. Keeping the performance of students from a borderline school in mind is an element of the standard-setting process.

The relative difficulty for a borderline school to achieve acceptable standards for a given domain is determined. In standard-setting procedures, committee members are provided with information that helps them decide how realistic their estimates might be. The committee members are asked to consider the question: In a borderline school, what will be the likelihood of achieving minimal competency in each of the domains? The exercise is an attempt to help committee members consider the constraints of borderline schools, recognize the existing realities and recognize that not all domains might be fully attainable. In doing so, committee members make decisions about issues such as what is ‘attainable’ and what is ‘tolerable’ for rating each item domain.

Committee members are provided with assessment materials. Committee members review all test items assigned to each domain by assessment type. If there are multiple methods for assessing a single domain, this process is repeated for each measurement type (MCQ, OSCE, faculty observation).

Student-level standards are set on the assessment materials for each domain. Committee members review the student-level standards or student cut-off score, for each of the assessment instruments and competency domains.

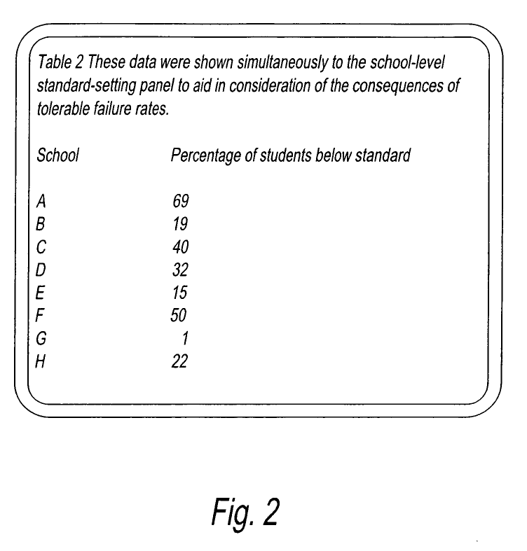

The next step includes generating committee members initial estimates of the percentage of students falling below the standard that is tolerable in a borderline school for each of the assessment instruments per domain. Initial ratings are projected on a screen and discussion of high and low ratings takes place. Anonymous school-level data from schools, such as, 8 leading schools in China, can be shown, indicating the consequences of the school-level cut-off scores on the percentages of students falling below the domain standard for each school (FIG. 1a, FIG. 2). FIG. 1a shows schools A through H and aggregate professionalism ratings from OSCE stations. This sample consequential data is shown after first round of rating with a heavy line representing a student-level standard set by a prior panel. Final revised ratings are discussed and defined. Ratings are applied to school-level data, with fewer failures than the school-level cut-off score constituting ‘strength’ and more failures constituting a ‘need for improvement’. The standard-setting process may take 3 days to complete.

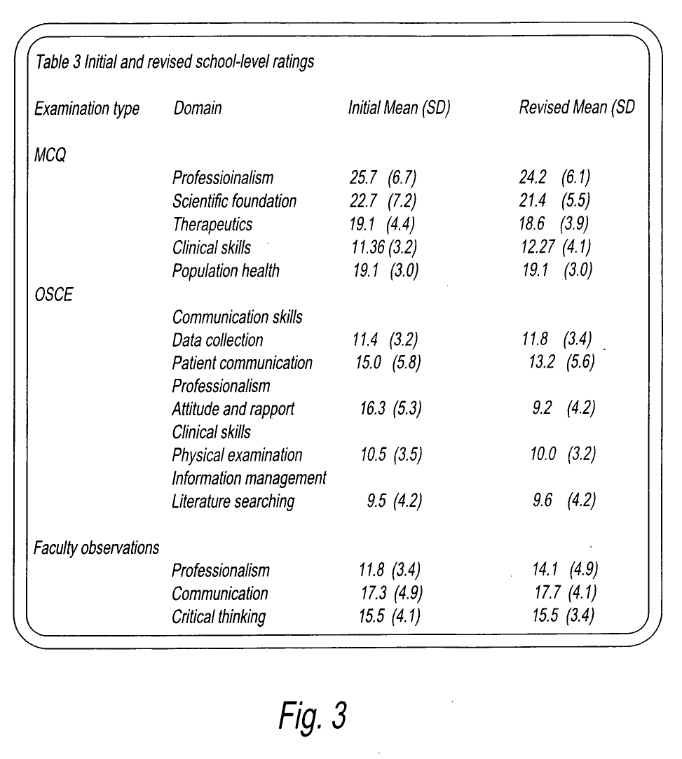

Across all modes of examination, initial tolerable failure rates may range from 10% to 26%, reflecting committee member raters' estimation of how well the domain is sampled, the accuracy of the assessment method, and the allowable percentage of failing students in a competent school, as shown in FIG. 3. These initial cut-off scores may be set after review of domains and examination materials, but before reviewing student or school failure rates. There may be little difference between initial and subsequent ratings after reviewing school failure rates.

In this standard-setting exercise, standard deviations may generally decrease from the initial to the final ratings, demonstrating group consensus development. An average rater stringency may range from 12.5% to 20% tolerable failure rates, indicating a fair degree of agreement on the overall range of acceptable failure in a competent institution.

Medical students can use data from an examination like this to determine whether their performance approximates international standards. Medical schools can use data from this evaluation to determine both the baseline strengths and weaknesses of their programs, as well as the impact of educational interventions with follow-up evaluation. Ministries and medical school organizations can use aggregate results across schools to determine funding priorities across institutions without concern for local biases.

The method of certifying schools is based on the performance of graduates on essential tasks, rather on the quality of the curriculum, excellence of teachers, or reputation of the institution. This method of certifying schools may provide a method to combine international expertise with objective independent measures of competence. This method allows for cross-institutional and cross-national comparison of competence of educational institutions. The method may assess characteristics of educational institutions on “outcome standards,” which may not be able to be performed by the institution itself, but only through external independent examination of the performance of graduates. The method establishes school-level standards to identify cut-off points above which the school can be considered competent.

While the instant disclosure has been described with reference to one or more exemplary embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this invention, but that the invention will include all embodiments falling within the scope of the appended claims.

What is claimed is:

1. A standard setting method for schools, said method comprising:
establishing a student level standard;
generating a school-level standard based on a percentage of students that meet said student-level standard for at least one performance criteria; and
generating a report.

2. The method of claim 1, wherein establishing said school-level standard comprises the step of identifying at least one panelist.

3. The method of claim 2, wherein said panelist reviews an examination that assesses said performance criteria, said student-level standard, and discusses characteristics of a hypothetical or real borderline school.

4. The method of claim 1, wherein establishing said school-level standard comprises estimating a percentage of said students below said student-level standard.

5. The method of claim 4, further comprising revising said estimated percentage.

6. The method of claim 5, further comprising averaging said revised percentage, thereby generating said school-level standard.

7. The method of claim 1, further comprising applying said school-level standard to each of said schools.

8. The method of claim 1, wherein generating a report comprises generating a report identifying a first category that is greater than said school-level standard, a second category that is less than said school-level standard and/or a third category within a predetermined borderline range of said school-level standard.

9. The method of claim 8, wherein said first category, said second category, and said third category include students, schools, or combinations of schools.

10. The method of claim 9, wherein said combinations of schools are by region or country.

11. The method of claim 1, further comprising identifying said performance criteria.

12. The method of claim 11, further comprising administering an examination which assesses a student's ability in said performance criteria.

13. The method of claim 12, wherein establishing a student level standard comprises establishing said student-level standard for said examination.

14. A method of establishing a school-level standard, said method comprising:
estimating percentages of students below a minimum student-level standard for a school;
revising said estimated percentages, thereby generating revised percentages;
averaging said revised percentages, thereby generating said school-level standard;
applying said school-level standard to schools; and
generating a report.

15. The method of claim 14, further comprising identifying at least one panelist.

16. The method of claim 15, wherein said panelist reviews an examination to assess said performance criteria, a student-level standard of said examination, and discusses characteristics of borderline schools.

17. The method of claim 14, further comprising identifying from among panelists' estimated percentages a high estimated percentage and a low estimated percentage, and wherein said high estimated percentage and said low estimated are discussed.

18. The method of claim 14, wherein generating a report comprises generating a report identifying a first category that is greater than said school-level standard, a second category that is less than said school-level standard and/or a third category within a predetermined borderline range of said school-level standard.

19. The method of claim 18, wherein said first category, said second category, and said third category include students, schools, or combinations of schools.

20. The method of claim 18, wherein said combinations of schools are by region or country.
